(19) United States
(12) Patent Application Publication
(10) Pub. No.: US 2005/0001426 A1
(43) Pub. Date: Jan. 6, 2005

(54) Leakage connection for connecting a leakage pipe to a fuel injector

(76) Inventors: Jurgen Dick, Laaber (DE); Willibald Schurz, Pielenhofen (DE); Martin Simmet, Bad Abbach (DE)

Correspondence Address: Andreas Grubert;Baker Botts L.L.P., One Shell Plaza, 910 Louisiana, Houston, TX, 77002-4995, US

(21) Appl. No.: 10/902,248

(22) Filed: Jul. 29, 2004

Related U.S. Application Data
(63) Continuation of application No. PCT/DE03/00225, filed on Jan. 28, 2003.

(30) Foreign Application Priority Data
Jan. 30, 2002 (DE) 10203600.4

(51) Int. Cl. F16L 37/00

(52) U.S. Cl. 285/321; 285/305

(57) ABSTRACT

A leakage connection for connecting a leakage pipe to a fuel injector which is inexpensive to produce and that can be easily and reliably mounted can be obtained by configuring a security device as a snap ring that can be inserted in a nipple groove configured on the periphery of an insert. A bore groove is configured in the inner peripheral wall of the bore and corresponds to the nipple groove. In the mounted state of the leakage connection, the snap ring, with a part of its wall thickness, lies in the bore groove and with the rest of its wall thickness in the nipple groove, thereby preventing the leakage connection from being unintentionally withdrawn.

### CROSS REFERENCE TO RELATED APPLICATION

This application is a continuation of copending International Application No. PCT/DE03/00225 filed Jan. 28, 2003 which designates the United States, and claims priority to German application no. 102 03 600.4 filed Jan. 30, 2002.

### TECHNICAL FIELD OF THE INVENTION

This invention relates to a leakage connection for connecting a leakage pipe to a fuel injector.

### DESCRIPTION OF THE RELATED ART

Such a leakage connection is known from EP 0 886 065, in which case for the injection system to function, one of the features required for each injector is a connection for returning a part of the diesel fuel that was fed to the injector to the tank of the vehicle. This leakage connection should be inexpensive to manufacture and easy to install and dismantle, but it should not be able to become disconnected by itself. According to EP 0 886 065, a wire clamp is taken as the basis to start from that requires a matching groove at the leakage connection. During installation, the leakage insert is first of all inserted in the leakage bore in the injector. The wire clamp is subsequently pressed from the side into the groove on the leakage insert in order to secure the leakage connection. As a result, the wire clamp is then accommodated in a slot-type guide that forms part of the injector housing. The leakage housing is dismantled in the opposite sequence.

The same applies to the leakage connection according to DE 199 40 387 in which case the wire clamp is kept in an opening at the connection piece with a first straight arm. With a second curved arm, a clamp connection with the insert of the connection nipple is made in a final stage of installation via a sufficiently deep recess in the bore on the connection piece.

### SUMMARY OF THE INVENTION

The object of the invention is to provide a leakage connection for connecting a leakage pipe to a fuel injector that is inexpensive to manufacture and that can be easily and reliably installed.

According to the invention, this object can be achieved by a leakage connection for connecting a leakage pipe to a connection piece of a fuel injector, comprising a connection nipple that is guided with an insert in a bore of the connection piece, and a flexural elastic securing device that retains the connection nipple in the bore, wherein the securing device is formed by a snap ring that can be inserted in a nipple groove configured on the periphery of the insert, wherein a bore groove is configured in the inner peripheral wall of the bore corresponding to the nipple groove, wherein in the mounted state of the leakage connection, the snap ring, with a part of its wall thickness, lies in the bore groove and with the rest of its wall thickness in the nipple groove, thereby preventing the leakage connection from being unintentionally withdrawn, and wherein a depth of the nipple groove is at least the same size as a diameter of the material of the snap ring.

The bore groove may have a withdrawal bevel on the periphery in the demounting direction. The connection nipple and the bore may have corresponding stops that limit the insertion path of the insert in the bore. The corresponding stops can be arranged at an angle to the longitudinal axis of the connection nipple. Below the corresponding stops, a second pair of corresponding stops can be arranged on the connection nipple or the bore, wherein the stops of the second pair are arranged at an angle to the longitudinal axis of the connection nipple and wherein an O-ring groove with an O-ring is arranged between the two stop pairs.

According to the invention, instead of the wire clamp, the leakage connection provides for a simple ring of spring steel particularly in the form of a snap ring. Thus, the snap ring is premounted on the leakage connection in a groove and is slotted on one side. The size of the slot must be dimensioned in such a way that when the leakage connection is installed, it must be possible to compress the snap ring to such an extent that it fits through the bore in the injector. At the leakage housing or the connection nipple, the shape of the groove provides a corresponding free space for the deformation of the snap ring. In the lower area of the leakage bore there is a corresponding groove in which the snap ring can again slacken. The leakage connection can then only be dismantled by overcoming the initial stressing forces of the snap ring. The peak of the installation and dismantling forces can be influenced by the rigidity of the spring of the snap ring as well as by mounting bevels on the leakage bore. Installation and dismantling is a simple matter of inserting or withdrawing. An additional advantage of the invention is the low production cost of the injector housing by omitting the guide for the wire clamp and the simple design of the snap ring compared with the wire clamp.

### BRIEF DESCRIPTION OF THE DRAWINGS

An embodiment of the leakage connection according to the invention is described below; the accompanying drawings are as follows:

FIG. 1 in a side view a fuel injector with the leakage connection,

FIG. 2 in a side view, an enlarged connection nipple of the leakage connection, as well as

FIG. 3 in a sectional view corresponding to FIG. 2, the leakage connection mounted in an opening of the fuel injector.

### DETAILED DESCRIPTION OF THE PREFERRED EMBODIMENTS

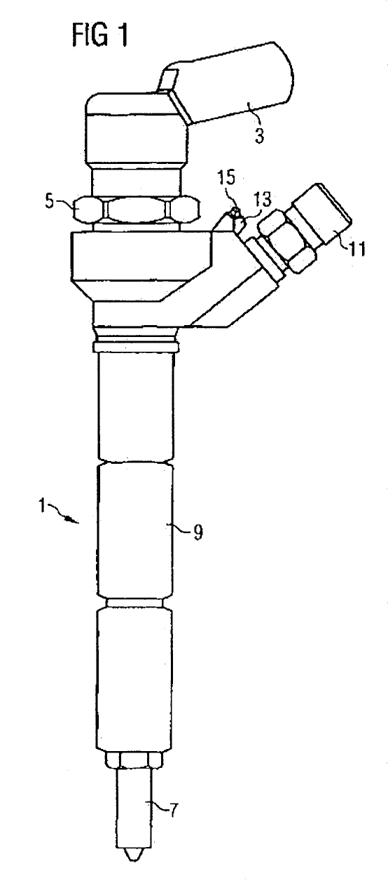

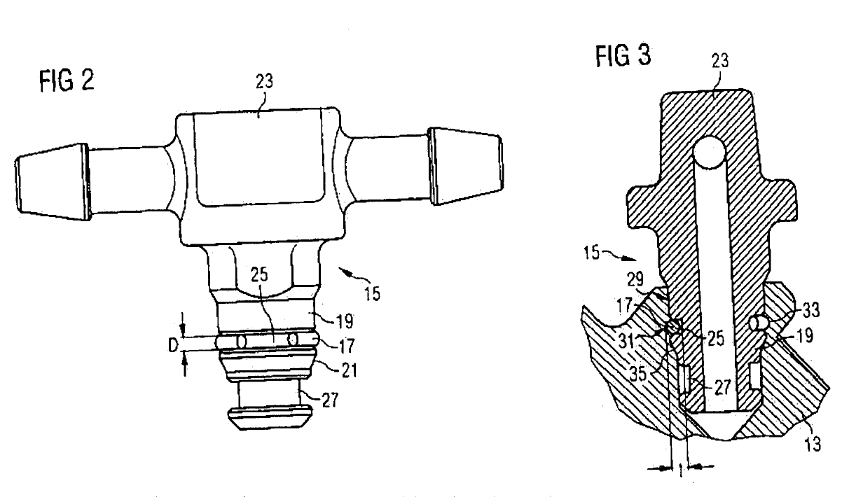

According to FIG. 1 the fuel injector 1 in essence consists of an actor connection 3, an actuator 5 and an injection nozzle 7. Thus, the drive 5 and the nozzle 7 are arranged in an injector body 9. In addition, the injector body provides both a high pressure connection 11 via which fuel can be fed to the fuel injector 1 under high pressure and a leakage connection via which excess fuel can be drawn off from the fuel injector 1. In essence, the leakage connection consists of a connection piece 13, a connection nipple 15 (shown very simplified in FIG. 1) and a snap ring 17 shown in FIGS. 2 and 3.

According to FIG. 2, the connection nipple 15 in particular has an insert 19 with a first stop 21 and a main body 23. A leakage pipe can be inserted in the main body of the connection nipple 15, said leakage pipe connecting the fuel injector 1 to the fuel reservoir (not shown). On the periphery of the insert 19, there are both a nipple groove 25 and an a-ring groove 27. The premounted snap ring 17 is held in the nipple groove 25. It can clearly be seen that the snap ring in the slack state has a larger ring diameter than the contour of the leakage connection or the insert 19 in the immediate vicinity thereof. On the other hand, the ring diameter is still small enough so that the slackened snap ring 17 is held securely in the nipple groove 25 on the connection nipple 15. The nipple groove has a depth t that is slightly bigger than the diameter D of the ring material.

FIG. 3 is a section of the connection pieces 13 of the injector body 9 and the connection nipple 15 in the installed state of the leakage connection. A bore 29 is machined in the connection pieces 13 or in the injector body 9, into which the insert 19 of the connection nipple 15 is inserted. As a result, the outside contour of the insert 19 is then adapted to the inside contour of bore 29. Corresponding to the nipple groove 25, the bore 29 has a bore groove 31 to partially hold the slack snap ring 17. The bore groove 31 is slightly beveled towards the top or in the dismantling direction and therefore has a withdrawal bevel 33 for easier dismantling of the leakage connection. In this case, in the installed state of the leakage connection, the snap ring 17, with a part of its wall diameter D, lies in the bore groove 31 of the bore 29 and with the rest of its wall thickness in the nipple groove 25, thereby preventing the leakage connection from coming undone unintentionally. Further below in the mounted direction, the bore 29 tapers down and accommodates an O-ring in the O-ring groove 27 that is not shown. Inserting the insert 19 in the bore 29 is limited by the first stop 21 of the connection nipple 15 resting against a second stop 35 on the inner wall of the bore 29.

1. A leakage connection for connecting a leakage pipe to a connection piece of a fuel injector, comprising a connection nipple that is guided with an insert in a bore of the connection piece, and a flexural elastic securing device that retains the connection nipple in the bore, wherein the securing device is formed by a snap ring that can be inserted in a nipple groove configured on the periphery of the insert, wherein a bore groove is configured in the inner peripheral wall of the bore corresponding to the nipple groove, wherein in the mounted state of the leakage connection, the snap ring, with a part of its wall thickness, lies in the bore groove and with the rest of its wall thickness in the nipple groove, thereby preventing the leakage connection from being unintentionally withdrawn, and wherein a depth of the nipple groove is at least the same size as a diameter of the material of the snap ring.

2. The leakage connection according to claim 1, wherein the bore groove has a withdrawal bevel on the periphery in the demounting direction.

3. The leakage connection according to claim 1, wherein the connection nipple and the bore have corresponding stops that limit the insertion path of the insert in the bore.

4. The leakage connection according to claim 3, wherein the corresponding stops are arranged at an angle to the longitudinal axis of the connection nipple.

5. The leakage connection according to claim 1, wherein below the corresponding stops, a second pair of corresponding stops are arranged on the connection nipple or the bore, wherein the stops of the second pair are arranged at an angle to the longitudinal axis of the connection nipple and wherein an O-ring groove with an O-ring is arranged between the two stop pairs.

6. A leakage connection for connecting a leakage pipe to a connection piece of a fuel injector, comprising:
a connection nipple that is guided with an insert in a bore of the connection piece,
a flexural elastic securing device that retains the connection nipple in the bore, wherein the securing device is formed by a snap ring that can be inserted in a nipple groove configured on the periphery of the insert having a depth at least the same size as a diameter of the material of the snap ring,
a bore groove in the inner peripheral wall of the bore corresponding to the nipple groove, wherein in the mounted state of the leakage connection, the snap ring, with a part of its wall thickness, lies in the bore groove and with the rest of its wall thickness in the nipple groove, thereby preventing the leakage connection from being unintentionally withdrawn.

7. The leakage connection according to claim 6, wherein the bore groove has a withdrawal bevel on the periphery in the demounting direction.

8. The leakage connection according to claim 6, wherein the connection nipple and the bore have corresponding stops that limit the insertion path of the insert in the bore.

9. The leakage connection according to claim 8, wherein the corresponding stops are arranged at an angle to the longitudinal axis of the connection nipple.

10. The leakage connection according to claim 6, wherein below the corresponding stops, a second pair of corresponding stops are arranged on the connection nipple or the bore, wherein the stops of the second pair are arranged at an angle to the longitudinal axis of the connection nipple and wherein an O-ring groove with an O-ring is arranged between the two stop pairs.
